(19) United States
(12) Patent Application Publication
(10) Pub. No.: US 2013/0102086 A1
(43) Pub. Date: Apr. 25, 2013

(54) METHODS AND APPARATUSES FOR DETECTING A CORROSION INHIBITOR

(71) Applicant: Regis J. Pellet, Croton on Hudson, NY (US)

(72) Inventor: Regis J. Pellet, Croton on Hudson, NY (US)

(73) Assignee: OLD WORLD INDUSTRIES, LLC, NorthBrook, IL (US)

(21) Appl. No.: 13/278,659

(22) Filed: Oct. 21, 2011

(51) Int. Cl. G01N 21/78

(52) U.S. Cl. 436/169

(57) ABSTRACT

Methods, apparatuses, compositions and kits are disclosed for detecting the presence or absence of an inhibitor in a fluid. In one embodiment, methods, apparatuses, compositions and kits are disclosed for determining if the level of a corrosion inhibitor in a coolant fluid is sufficient to provide protection against corrosion.

### FIELD

Embodiments disclosed herein related to methods, apparatuses, compositions and kits for detecting the presence of a compound of interest. In one embodiment, methods, apparatuses, compositions and kits relate to detecting the presence of an inhibitor in a coolant. In yet another embodiment, methods, apparatuses, compositions and kits are disclosed for determining the presence or absence of a corrosion-inhibitory level of an inhibitor in a coolant fluid.

### BACKGROUND

Engine cooling systems contain a variety of metals that need to be protected against corrosive attack, which is caused by decomposing coolant, coolant contaminants and by high temperatures. For this reason, engine coolants will contain inhibitors to protect against corrosive attack on the cooling systems metals. For example, nitrite or molybdate anions are often added to a coolant to protect against cast iron corrosion. It is essential that effective levels of all inhibitors are maintained in order to assure adequate protection of the system. Coolant aging or over-dilution with water or with other coolants lacking the required ingredients can lead to a drop-off in inhibitor levels and therefore, a drop off in corrosion protection. Thus, it has become a practice to periodically measure corrosion inhibitor levels to assure proper inhibition and to refortify as dictated by the results of these measurements.

Engine maintenance shops have limited testing capabilities, and therefore, it is highly desirable that required coolant inhibitor testing be quick and simple. Engine maintenance shops lack equipment to deliver precise volumes and weights of reagents to measure inhibitor levels. The ability to mix reagents with coolant and to separate reaction products from reactants (e.g. by filtration) is limited. Even if the equipment exists, time constraints would make this approach undesirable.

More recently, coolants employing organic inhibition for corrosion protection, such as carboxylate anions, have become popular. Coolants based on carboxylate anions degrade at a reduced rate relative to coolants based on inorganic inhibitors such as nitrite. For this reason, these coolants are referred to as extended life coolants or as organic additive technologies (OAT's). Inhibitor depletion due to degradation is less of an issue with OAT coolants, carboxylate inhibitors still can become over-diluted when the engine's cooling system is topped off with water or with another coolant that does not contain carboxylate anion. Because of the potential for dilution, testing the carboxylate level is essential in order to assure adequate corrosion protection. Prior to the methods and apparatuses disclosed herein, there were no simple tests available to measure carboxylate levels in the field. Existing tests for carboxylate levels require precise measurements of reagents and coolants. Reaction vessels are also needed to mix and have the components react. Often separation of reactants and products is required in order to observe product color and this in turn has required filtration steps and filtration devices. Because of the complexity of testing for carboxylate anions, testing may be preformed less frequently than needed.

Therefore, a need still exists for methods, compositions, apparatuses and kits that can be used to test the level of a corrosion inhibitor, such as carboxylate, in a fluid, such as a coolant.

### BRIEF SUMMARY

In one embodiment, the disclosure provided herein relates to a method for the preparation of a test strip. In one embodiment, the test strip may be used to indicate the relative level of a corrosion inhibitor. In another embodiment, the disclosure provided herein relates to a method to determine relative level of an inhibitor. In another embodiment, the disclosure provided herein relates to a method to determine if sufficient corrosion inhibitor is present in a coolant to prevent corrosion.

In one embodiment, the disclosure provides a test device comprising an elongated body with a first porous portion and a second porous portion located on opposite ends of the elongated body, wherein the first porous portion comprises a colored reagent comprising a soluble metal salt and a color indicator and the second porous portion is free of colored reagent, and further wherein the elongated body permits contact between the first porous portion and the second porous portion.

In yet another embodiment, the disclosure provides a test device comprising a first substrate comprising a porous reaction zone comprising a colored reagent and a second substrate comprising a porous zone that is free of colored reagent.

In still yet another embodiment, the metal salt is salt selected from the group consisting of aluminum, tin and iron.

In another embodiment, the disclosure provides a method for determining the presence or absence of a corrosion-inhibitory level of an inhibitor in a coolant fluid comprising: (a) providing a test substrate comprising a first porous portion comprising a colored reagent of metal salt and a color indicator and a second porous portion free of the colored reagent; (b) bringing a sample of a coolant fluid into contact with the first porous portion; (c) bringing the first porous portion into contact with the second porous portion; and (d) observing any color change in the second porous portion.

An advantage of the disclosure is a test device comprising one reaction zone containing a preformed color reagent. A test device with a single reaction zone makes fabrication much simpler.

An advantage of the disclosure is a test strip comprising two porous portions, one to serve as a reaction zone and one to serve as a blotter.

An advantage of the disclosure is a test strip that uses a blotter pad to more accurately detect the presence of an inhibitor of interest.

An advantage provided by the methods disclosed herein is that the methods can be used routinely to detect coolant conditions that need remediation, thus avoiding expensive cooling system repair.

An advantage of the methods and apparatuses herein is that they avoid the need to accurately measure precise and known quantities of coolant and reactants. Also avoided is the need for devises to collect, hold and filter reactants and reaction products.

An advantage of the methods and apparatuses disclosed herein is that there is no need for filtration or mixing of reagents. In addition, there are no liquid reagents or indicators that may decompose with time.

### BRIEF DESCRIPTION OF THE DRAWINGS

FIG. 1 is a schematic of a representative example of a test device disclosed herein.

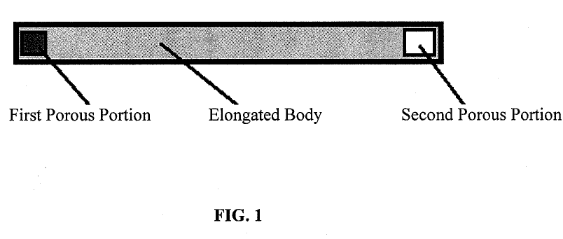

### DETAILED DESCRIPTION

### Definitions

The numerical ranges in this disclosure are approximate, and thus may include values outside of the range unless otherwise indicated. Numerical ranges include all values from and including the lower and the upper values, in increments of one unit, provided that there is a separation of at least two units between any lower value and any higher value. As an example, if a compositional, physical or other property, such as, for example, molecular weight, viscosity, melt index, etc., is from 100 to 1,000, it is intended that all individual values, such as 100, 101, 102, etc., and sub ranges, such as 100 to 144, 155 to 170, 197 to 200, etc., are expressly enumerated. For ranges containing values which are less than one or containing fractional numbers greater than one (e.g., 1.1, 1.5, etc.), one unit is considered to be 0.0001, 0.001, 0.01 or 0.1, as appropriate. For ranges containing single digit numbers less than ten (e.g., 1 to 5), one unit is typically considered to be 0.1. These are only examples of what is specifically intended, and all possible combinations of numerical values between the lowest value and the highest value enumerated, are to be considered to be expressly stated in this disclosure. Numerical ranges are provided within this disclosure for, among other things, relative amounts of components in a mixture, and various temperature and other parameter ranges recited in the methods.

The term “antifreeze” refers to a composition that reduces the freezing point of an aqueous solution, or is an aqueous solution with a reduced freezing point with respect to water, e.g., a composition comprising a freezing point depressant.

The term “antifreeze” composition (or fluid or concentrate) may be used interchangeably with “heat transfer,” “coolant,” or “de-icing” fluid (composition or concentrate).

The term “coolant” refers to a category of liquid antifreeze compositions which have properties that allow an engine to function effectively without freezing, boiling, or corrosion. The performance of an engine coolant must meet or exceed standards set by the American Society for Testing and Materials (A.S.T.M.) and the Society of Automotive Engineers (S.A.E.).

The term “colored complex” refers to a color indicator and a chemical reagent complex. “Colored complex” includes but is not limited to a colored reagent.

The term “colored reagent” refers to a color indicator and a soluble metal salt.

The term “de-icing” fluid refers to a fluid which makes or keeps a system, a device, or a part free of ice, or a fluid which melts ice.

The term “glycol-based” includes glycols, glycerins, as well as glycol ethers.

The term “heat transfer fluid” refers to a fluid that flows through a system in order to prevent its overheating, transferring the heat produced within the system to other systems or devices that can utilize or dissipate the heat.

The term “test device” may be used interchangeably with “test strip,” test substrate” or “test matrix,” referring to a device for detecting a substance of interest.

The term “strip” refers to a long narrow piece of material, usually of uniform width.

The term “substantially reacted” refers to a chemical reaction that is complete enough to provide the desired effects without any negative consequences or false positives from un-reacted components. The term “substantially reacted” may include a reaction that is from 85% to 90%, 91 to 95%, or from 96-100% complete.

The term “substantially precipitated” refers to the formation of a precipitate that is complete enough to provide the desired effects without any negative consequences or false positives from unprecipitated components. The term “substantially precipitated” may include a reaction that is from 85% to 90%, 91 to 95%, or from 96-100% complete.

### I. Test Device

In one embodiment, the disclosure provides a test device for detecting the presence or absence of a substance of interest. In another embodiment, a test device is disclosed for detecting the presence of an inhibitor. In still yet another embodiment, a test device is disclosed for detecting the presence of a corrosion inhibitor in a coolant, and determining if there is adequate corrosion inhibitor to provide corrosion protection. In yet another embodiment, the test device can be used to determine if the level of an inhibitor in an OAT coolant is adequate to provide corrosion protection. The test device can be designed for a single use or for multiple uses. In one embodiment, the test device can comprise a substrate that comprises corner “a,” corner “a1,” corner “b,” and corner “b2.” Corners “a” and “a1” are located across from one another as are corners “b” and “b2.” Corners “a” and “b” can comprise a colored reagent and corners “a1” and “b2” can comprise a substrate free of colored reagent. In one embodiment, coolant can be placed on corner “a” be brought into contact with “a1.” At a later time, coolant, either the same coolant or a different coolant, can be placed on corner “b.” This is one non-limiting manner in which a test substrate can be designed for multiple uses.

In one embodiment, an array of test devices can be produced on a single sheet. The test devices can be separated by a perforated line, allowing for easy separation.

In yet another embodiment, the test device comprises a substrate with a reaction zone comprising a colored complex and a second zone that is free of colored complex and serves as a blotter for the reaction zone. In still yet another embodiment, the test device comprises a first substrate with a reaction zone comprising a colored complex and a second substrate with a second zone that is free of colored complex and serves as a blotter for the reaction zone. In one embodiment, the substrate is an elongated body.

In still another embodiment, a test device comprises a substrate comprising a first porous portion comprising a colored complex and a second porous portion, which is free of colored complex and functions as a blotter pad. In another embodiment, a test device comprises a first elongated body comprising a first porous portion comprising a colored complex and a second elongated body comprising a second porous portion free of colored complex.

In yet another embodiment, the test device comprises a substrate with a reaction zone comprising a colored reagent and a second zone that is free of colored reagent and serves as a blotter for the reaction zone. In still yet another embodiment, the test device comprises a first substrate with a reaction zone comprising a colored reagent and a second substrate with a second zone that is free of colored reagent and serves as a blotter for the reaction zone. By use of the term “blotter,” it is meant that the second substrate is brought into at least some contact with the first substrate and may absorb un-precipitated color reagent from the first substrate. In one embodiment, the substrate is an elongated body.

In still another embodiment, a test device comprises a substrate comprising a first porous portion comprising a colored reagent and a second porous portion, which is free of colored reagent and functions as a blotter pad. In another embodiment, a test device comprises a first elongated body comprising a first porous portion comprising a colored reagent and a second elongated body comprising a second porous portion free of colored reagent.

In one embodiment, the test device comprises a first elongated body with a reaction zone comprising a colored reagent and a second elongated body with a blotter zone that is initially free of colored reagent and functions as a blotter for the reaction zone. In yet another embodiment, the elongated body may be porous or non-porous. In another embodiment, the elongated body may be flexible or rigid.

In one embodiment, the test device comprises a first elongated body with a first porous portion comprising a colored reagent and a second elongated body with a second porous portion that is free of colored reagent and functions as a blotter for the first porous portion. Upon contact between the first porous portion and the second porous portion, colored reagent may be present on the second porous portion.

In another embodiment, the test device comprises an elongated body with at least two portions: a first portion comprising a colored reagent and a second portion that is free of colored reagent and serves as a blotter to the first portion.

In another embodiment, the test device comprises an elongated body with at least two porous portions: a first porous portion serving as a reaction zone and a second porous portion serving as a blotter, which is free from any reactive material. In one embodiment, the porous portions of the elongated body are separated so that during application of the test substance to the reaction zone, the test substance does not contact the blotter pad. The porous portions of the elongated body may be separated by any distance, including but not limited to 2, 3, 4, 5, 6, 7, 8, 9, 10, 11, 12, 13, 14, 15, 16, 17, 18, 19, 20, and greater than 20 centimeters. The porous portions can be coupled to a flexible non-porous elongated body using any suitable means. In one embodiment, the porous portions are porous pads.

The first porous portion of an elongated body may function as a reaction zone and contains a colored complex comprising a color indicator and a first reagent. The colored complex will react with a second reagent to form an insoluble precipitate. A substance comprising a second reagent can be applied to the first porous portion. A second porous portion is free of colored complex and serves as a blotter to receive un-reacted colored complex when pressed against the first porous portion. If there is insufficient second reagent to substantially precipitate the colored complex, then when pressed against the second porous portion, the colored complex will change the color of the second porous portion. Conversely, if there is sufficient second reagent to precipitate the colored complex, then when pressed against the second porous portion, there will be no free colored complex remaining and the blotter pad will remain the original color or assume the color of the substance.

In one embodiment, the first porous portion is located on a first elongated body and a second porous portion is located on a second elongated body. In one embodiment, the elongated body can be a flexible sheet of material. In still yet another embodiment, the elongated body may be made of a rigid material.

In another embodiment, the first porous portion and the second porous portion are located on a single elongated body. The components and reagents necessary for performing the test are located on one convenient elongated body. There is no need to transfer reagents or material from one location to another. Rather, the test device ca simply be folded upon itself to place the first porous portion and the second porous portion in contact.

A. Substrate

In one embodiment, a test device comprises a substrate. In yet another embodiment, the substrate is made of porous material. In still another embodiment, the substrate is made of flexible material. In yet another embodiment, the substrate is an elongated body.

In one embodiment, the substrate is a strip of material. In another embodiment, the substrate can be of any desired shape including but not limited to a square, a rectangle, a circle, or a triangle.

In yet another embodiment, the substrate can be made of any flexible material including but not limited to plastic, rubber, low density poly ethylene (LDPE), very low density polyethylene, polystyrene, and polyethylenterephthalate, and cardboard. The substrate can be any desired dimensions including but not limited to a width of 0.1-0.2, 0.2-0.3, 0.3-0.4, 0.4-0.5, 0.5-0.6, 0.6-0.7, 0.7-0.8, 0.8-0.9, 0.9-1 inch and greater than one inch in width. The substrate can be of any desired length including but not limited to 1-2, 2-3, 3-4, 4-5, 5-6, 6-7, 7-8, 8-9, 9-10, and greater than 10 inches in length.

In one embodiment, the substrate is composed of a non-porous, non reactive flexible plastic sheet that can be bent so that the reactive pad at one end can be brought into contact with the non-reactive pad at the opposite end of the flexible sheet. In one embodiment, the substrate is flexible enough to bend from 90° to 180° or from 181° to 270° or from 271° to 360°.

In another embodiment, the substrate can be made of a non-flexible material including but not limited to high density polyethylene, composite fibers, composite wood, glass, and wood. A non-flexible substrate can comprise a first porous portion comprising a reaction zone with a colored reagent comprising dye and a first reagent. The non-flexible substrate with the first porous portion can be used in conjunction with any source of a second porous material including but not limited to a second non-flexible elongated body, a second flexible elongated body, a cap, a bottle, a cloth, a disposable wipe, a brush, and a dipping stick.

B. Porous Portions of a Substrate

In one embodiment, a substrate comprises a porous portion. In another embodiment, a substrate comprises 2, 3, 4, 5, 6, 7, 8, 9, 10 or greater than 10 porous portions.

In another embodiment, the porous portion of a substrate is a porous pad. In one embodiment, the porous portions are etched into the substrate. In another embodiment, porous portions may be coupled to a substrate using any suitable means in the industry including but not limited to tape, double-sided tape, contact cement, glue, super-glue, and epoxy-resins.

A porous portion of the substrate can be made of any porous material suitable to retain a fluid. The porous portion of the substrate can be made from paper, woven fiber or filament, blotter paper, Ahlstrom blotter paper, Whatman paper, chromatography paper, filter paper, cellulose nitrate, flash paper, nitrocellulose, and polyvinylidene fluoride. The porous portion of the elongated body can be cut to any configuration including but not limited to a circle, a square, a rectangle, a triangle, an octagon and a pentagon.

In one embodiment, the porous portion of the substrate can have any suitable dimensions including but not limited of 0.1-0.2, 0.2-0.3, 0.3-0.4, 0.4-0.5, 0.5-0.6, 0.6-0.7, 0.7-0.8, 0.8-0.9, 0.9-1 inch and greater than one inch in width. The porous portion can have any suitable dimensions including but not limited of 0.1-0.2, 0.2-0.3, 0.3-0.4, 0.4-0.5, 0.5-0.6, 0.6-0.7, 0.7-0.8, 0.8-0.9, 0.9-1 inch and greater than one inch in length.

The porous portions of the substrate are selected from media that have sufficient pore volume to absorb a portion of the liquid to be tested or placed on the pads. The porous portions of the substrate also are selected to have a pore diameter that will not allow escape of insoluble material but will let soluble reactants and products egress unimpeded.

In one embodiment, the porous portion of the substrate is a pad with a smooth-textured paper low in organic and inorganic impurities, and having uniform physical characteristics. Examples include filter paper, chromatographic paper, and the like. In one embodiment, the paper is a commercial grade of cellulosic chromatographic paper especially manufactured for chromatography. Examples of suitable papers include Whatman thin layer chromatographic papers such as Whatman Nos. 2 to 4, and papers available from Ahlstrom such as Ahlstrom 238 Medium Thick Chromatography Paper (with a spec. of 0.35 mm-140 mm/30 min) and Ahlstrom 610.

In still yet another embodiment, porous material that is free of colored reagent and functions as a blotter for the colored reagent can be located on any suitable apparatus including but not limited to a bottle, a bottle cap, the bottom of a bottle, the top of a bottle, a brush, a stick, a dipping stick, a wipe, and a disposable wipe.

C. Colored Reagent

In one embodiment, the substrate comprises a first porous portion comprising a colored reagent. In yet another embodiment, the substrate comprises a reaction zone comprising a colored reagent. The colored reagent comprises a soluble metal cation and a color indicator.

1. Metal Cations

In one embodiment, the colored reagent comprises a metal cation. In another embodiment, the metal cation can be a trivalent cation. In another embodiment, the metal cation is provided through a soluble metal salt.

In one embodiment, the salt can be a trivalent cation salt. The metal salt can be any salt that forms an insoluble or nearly insoluble complex with the corrosion inhibitors that are commonly used in coolants. Examples of metal cations that can be used in the test device include calcium (II), iron (II), iron (III), magnesium (II), tin (II), tin (IV), zirconium (IV), aluminum (III), chromium (III), lanthanides, lanthanum, cerium, Praseodymium, neodymium, promethium, samarium, europium, gadolinium, terbium, dysprosium, holmium, erbium, thulium, ytterbium, lutetium, actinides, actinium, thorium, protactinium, uranium, neptunium, plutonium, americium, curium, berkelium, californium, einsteinium, fermium, mendelevium, nobelium, and lawrencium. It is envisioned that the metal cations referenced herein can be used in multiple valencies.

Examples of metal salts include but are not limited to calcium chloride (CaCl₂), calcium sulfate (CaSO₄), calcium nitrate (Ca(NO₃)₂), ferric chloride hexahydrate (FeCl₃.6H₂0), ferric sulfate (Fe₂(S0₄)₃, ferric choloride (FeCl₃), ferric nitrate (Fe(N0₃)₃), magnesium chloride (MgCl₂), magnesium sulfate (MgSO₄), magnesium nitrate (Mg(NO₃)₂), zirconium oxychloride (ZrOCl₂), zirconium nitrate (Zr(NO₃)₄), zirconium sulfate (Zr(SO₄)₂), zirconyl nitrate (ZrO(NO₃)₂), aluminum sulfate (Al₂(SO₄)₃), aluminum potassium sulfate (AlK(SO₄)₂), aluminum nitrate (Al(NO₃)₃), tin sulfate SnS0₄, tin chloride (SnCl₄), tin nitrate (Sn(N0₃)₂), chromium acetate (Cr(CH.₃COO)₃), chromium nitrate (Cr(NO₃)₃), chromium sulfate (Cr₂(SO₄)3), chromium oxalate (Cr₂(C₂O₄)₃), copper sulfate (CuSO₄), and copper nitrate (Cu(NO₃)2H₂O).

In one embodiment wherein the corrosion inhibitor is selected from the group of alkali metal or ammonium salts of carboxylic acids, e.g., sodium ethylhexanoate, potassium ethylhexanoate, etc., the soluble metal is a soluble aluminum compound selected from the group of chlorides, sulfates, nitrates, etc., of aluminum and their hydrates. An example is aluminum nitrate nonahydrate, Al(NO₃).₃.9H₂O.

In one embodiment wherein the corrosion inhibitor is an aromatic carboxylate, the soluble metal salt may be a soluble cobalt salt selected from the group of cobalt chloride, cobalt nitrate, and cobalt acetate.

Each salt will have a varying degree of effectiveness due to the different stoichiometry of reaction with carboxylate and due to different formula weights. The amount and concentration of salt that is effective can be determined using the methods known to those of ordinary skill and using the methods described herein. The amount of carboxylate to metal ion in the precipitate varies from greater than 1 to less than 4 and this is a factor of the choice of metal, the valency, and the number of acid functions of the carboxylate (e.g., monoacid, diacid).

2. Color Indicator

The color indicator comprises any dye that reacts with a metal cation or a metal salt. The color change may be from colorless to a color, or it may be from a first color to a second color. The type of color indicators to be used and the concentration of color indicators for use in the test device vary according to the type of engine coolant being tested, e.g., the type of corrosion inhibitors employed in the coolant and/or whether a coolant is dyed a certain color.

In one embodiment, the choice of color indicator depends on the choice of metal. Suitable color indicators that can be used to detect organic indicators such as carboxylic acids and salts are known to those skilled in the art, including but not limited to pyrocatechol violet (PCV), hematoxylin, Eriochrome Cyanine R, aurintricarboxylic acid, Pantachrome Blue Black R, Alizarin S, and the like. In one embodiment with Fast Red TR salt as the color indicator reagent, the color indicator sample may undergo a change from colorless to yellow. Suitable color indicators for use in detecting the presence of metal ions (in the soluble metal salt) are known in the art, including 5-(4-dimethylaminobenzylidene)rhodanine for analysis of copper ions, and 2,4,6-tri(2-pyridinyl)-1,3,5-triazine (TPTZ) for detecting iron ions.

In one embodiment, the concentration of the color indicator is chosen so that the color indicator is substantially reacted with the metal cation. Free color indicator will not be precipitated when the carboxylate is added, and therefore, will be able to migrate to the second porous portion and indicate a false positive. The amount of color indicator is chosen to be the minimal amount that is still readily and easily visible.

### II. Test Device for Detecting Corrosion Inhibitors

In one embodiment, a test device can be used to detect the presence or absence of corrosion inhibitors. The test device can be for a single use or for multiple uses. The test device can comprise a first elongated body with a porous portion that comprises a reaction zone and a second elongated body with a second porous portion, which is free of reagent and function as a blotter pad.

In another embodiment, the test device comprises an elongated body with two porous portions, which are located on opposite ends of the elongated body. The elongated body can be made of flexible, non-porous material. The first porous portion serves as a reaction zone and contains a soluble, colored reagent that will react with a corrosion inhibitor to form an insoluble precipitate; the second porous portion is free of colored reagent and serves as a blotter to receive unreacted soluble colored reagent when pressed against the first porous portion. The first porous portion comprises a dye indicator and a metal salt, which form the colored reagent, and will react with a corrosion inhibitor to form an insoluble precipitate. The first porous portion will be designed such that there is sufficient reagent to precipitate the minimum amount of corrosion inhibitor that is required for adequate corrosion protection. This minimal amount of corrosion inhibitor needed for adequate corrosion protection can be determined by any of the industry standard corrosion test methods such as those described by ASTM D 15.

If there is sufficient corrosion inhibitor present in the coolant to precipitate the entire colored reagent in the first porous portion, there will be no excess, unreacted colored reagent after it has been exposed to the coolant. If the entire colored reagent has been precipitated upon exposure to the coolant, then when pressed against the second porous portion, the second porous portion will be free of the colored reagent and only the color of the coolant being testing would be visible in the second porous portion. This would indicate that the coolant had sufficient corrosion inhibitor to precipitate all the soluble colored reagent.

If there is insufficient carboxylate in the coolant to completely precipitate the colored reagent, there will be unreacted, soluble, colored reagent present in the first porous portion. After exposure to the coolant, the first porous portion is brought into contact with the second porous portion; liquid from the first porous portion flows to the second porous portion. If there is unreacted colored reagent, the colored reagent will be visible in the second porous portion and indicate that the coolant does not have sufficient corrosion inhibitor. This coolant would have inadequate corrosion protection.

Multiple test devices can be produced on a single array or sheet. The array can have perforated lines to allow for easy separation of the test devices. The test devices can be produced with first porous portions comprising the same amount of colored reagent or with first porous portions comprising different amounts of colored reagent. For example, an array can be produced with three test devices. The first test device can have a reaction zone with a large amount of colored reagent. The second test device can have a reaction zone with a medium amount of colored reagent and the third test device can have a reaction zone with a small amount of colored reagent.

In one embodiment, the porous media chosen has a sufficiently restrictive pore structure so that solid precipitate particles formed in the reaction of colored reagent and corrosion inhibitor can not escape the first porous portion. However, if soluble, unreacted colored reagent is present in the first porous portion, this soluble material will pass through the first porous portion matrix and into the second porous portion where it will be visible and signal insufficient carboxylate for complete precipitation. Detection of the colored reagent in the second porous portion indicates insufficient corrosion protection. On the other hand, absence of the colored reagent in the second porous portion signals adequate corrosion protection.

First Porous Portion of an Elongated Body: Colored Reagent

The first porous portion comprises a colored reagent comprising a soluble metal cation and a color indicator. The components of the colored reagent are discussed above in section entitled “Metal Cation” and “Color Indicator.”

Corrosion Inhibitors

Not to be bound by any particular theory, it is believed that corrosion inhibitors, e.g, alkyl carboxylates, provide metal corrosion protection in coolant systems by forming a metal complex (or soap) on the metal components surface where potential corrosion may be imminent. These soaps are insoluble and form a protective barrier at the site of imminent corrosion and nowhere else, thus the corrosion inhibitors can protect aluminum, iron and other metal by this very localized insoluble soap formation. When a solution of metal cations is added to a coolant containing corrosion inhibitors, it forms a metal soap or complex which can be observed as an insoluble (or nearly insoluble in concentrations of less than 100 μg per liter of water, referred herein as “insoluble”) precipitate in solution.

If a sufficient level of corrosion inhibitors is present in the coolant to precipitate the entire colored reagent in the first porous portion, there will be no excess, un-reacted colored reagent after it has been exposed to the coolant. If the entire colored reagent has been precipitated upon exposure to the coolant, then when pressed against the second porous portion, the second porous portion will be free of the colored reagent and only the color of the coolant being testing would be visible in the second porous portion. This would indicate that the coolant had sufficient corrosion inhibitor to substantially precipitate the soluble colored reagent.

In one embodiment, the corrosion inhibitors are organic corrosion inhibitors, e.g., organic acids or soluble salts thereof, commonly used to improve corrosion inhibition properties of metals and metal alloys. Examples include azoles, which are typically used for copper and copper alloys; linear and branched aliphatic and aromatic organic acids (C₅-C₁₆) or alkali- or amino salt of linear and branched organic acids; aliphatic mono and di-acids (C₅-C₁₂), aromatic organic acids (C₇-C₁₈), or substituted aromatic organic acids (C₇-C₁₈) or ammonium, alkali- or amino salt of the foregoing acids; and mixtures thereof.

Specific examples of azoles include thiazoles and triazoles, for instance mercaptobenzothiazole, tolyltriazole, benzotriazole, 5-methylbenzotriazole, 2,5-dimercapto-1,3,4 thiadiazole (DMCT) and 1-pyrrolidine thiocarboic (1-PYRR) acid salts. Active azole levels typically used in corrosion inhibitor systems range from 0.1 to 15 parts, based upon the total weight of the coolant composition.

In one embodiment, the corrosion inhibitor is an aliphatic mono acid (a C₅-C₁₂ aliphatic monobasic acid) or the alkali metal, ammonium, or amine salt thereof, e.g., ethylhexanoic, heptanoic, octanoic, nonanoic, decanoic, undecanoic and dodecanoic acids, and mixtures thereof. In another embodiment, the corrosion inhibitor to be detected is an alkali metal, ammonium, or amine salt of a monobasic acid.

In one embodiment, the organic corrosion inhibitor is selected from the group of aromatic organic acids and hydroxyl-substituted aromatic organic acids, including but not limited to benzoic acids, C₁-C₈-alkylbenzoic acids/salts thereof, for example o-, m- and p-methylbenzoic acid or p-tert-butylbenzoic acid, C₁-C₄-alkoxybenzoic acids, for example o-, m- and p-methoxybenzoic acid, hydroxyl-containing aromatic monocarboxylic acids, for example o-, m- or p-hydroxybenzoic acid, o-, m- and p-(hydroxymethyl)benzoic acid, a halobenzoic acids, for example o-, m- or p-fluorobenzoic acid. In one embodiment, the aromatic organic acid is selected from 2-hydroxybenzoic acid, p-terbutylbenzoic acid, mandelic acid and homophthalic acid and salts thereof.

In one embodiment, the corrosion inhibitor is selected from the group of carboxylic acids and salts thereof, e.g., alkali metal salts such as sodium or potassium salts, or as ammonium salts or substituted ammonium salts (amine salts), for example with ammonia, trialkylamines or trialkanolamines.

In one embodiment, the corrosion inhibitor is selected from the group of alkali metal or ammonium salts of carboxylic acids that form a water insoluble aluminum-carboxylate complex upon reaction with a source of aluminum cation. Examples of such alkali metal or ammonium salts include suberic acid, azelaic acid, undecanedioic acid, dodecanedioic acid, valeric acid, caproic acid, ethylhexanoic acid, octanoic acid, nonanoic acid, decanoic acid and undecanoic acid and their isomers, cyclohexane carboxylic acid, and the like. In another embodiment, the carboxylate corrosion inhibitor is an alkali metal ethylhexanoate, e.g., sodium ethylhexanoate, potassium ethylhexanoate, etc.

In yet another embodiment, the carboxylate corrosion inhibitor is para tertbutyl benzoic acid.

### III. Methods of Producing a Test Device

A. Preparation of the Colored Reagent

A color indicator stock solution can be prepared by dissolving a suitable amount of color indictor, such as pyrocatechol violet (PVC), in deionized water to obtain a desired stock solution. A metal salt solution can be prepared by dissolving a suitable amount of the desired metal salt in deionized water to obtain a suitable stock solution.

The final colored reagent can be prepared by diluting the color indicator stock to a suitable concentration with deionized water and mixing this diluted indicator with the metal salt solution. Upon mixing, a color reagent will be formed between the metal ion and the color indicator dye. It is desirable if no precipitate or solids are observed to form.

B. Elongated Body

In one embodiment, the elongated body can be any suitable material. In another embodiment, the elongated body can be any suitable flexible, non-porous material. In still another embodiment, the elongated body can be made of porous material. In yet another embodiment, an elongated body comprises a first porous portion with colored reagent, as described above. Along the opposite side of this elongated body, a second porous portion porous with no color reagent can be coupled to the elongated body. The porous portions of the elongated body can be affixed using any suitable means known in the industry including but not limited to permanent double sided tape (Scotch brand from 3M), contact cement, glue, and epoxy-resins. The elongated body with attached pads can then cut into the desired sizes.

C. Porous Portions of an Elongated Body

Sheets of a porous material, including but not limited to Ahlstrom blotter paper 237, can be cut to the desired dimensions. Some porous material will receive no colored reagent (blotter), and other porous material can be submersed in the colored reagent to saturate the pore structure of the porous material (reaction zone) and then the paper can be air dried at room temperature using any suitable method including but not limited to vacuum drying. The porous material can then be stored in a desicator to remove all easily evaporated moisture. After drying, the porous material can be cut into the desired dimensions.

In yet another embodiment, the porous material can be coupled to an elongated body first and then the elongated body can be cut to the desired dimensions. By way of example and not to be bound by this example, strips of a first porous material with a reaction zone and strips of a second porous material free of colored reagent can be coupled to the elongated body. The elongated body then can be cut to the desired dimensions.

### IV. Method of Using the Test Device

In another embodiment, methods for testing for the presence of a corrosion inhibitor are provided. In another embodiment, methods are provided for determining if the level of a corrosion inhibitor is sufficient to provide protection. In one embodiment of the testing process, a small quantity of engine coolant is withdrawn from the cooling system to provide a representative sample whose organic corrosion inhibitor content is to be determined. A typical representative sample can be as little as a few droplets (or drops). The droplets can be picked up/withdrawn from the cooling system using any of a pasteur pipette, a medicine dropper (a tube with a suction bulb at the end), a syringe, a suction bottle, or a simple stick or tube for insertion into the coolants to be tested and which would hold/retain a few drops of liquid thereon. Depending on the method used to withdraw the coolant sample from the system, e.g., a medicine dropper or a syringe, each drop typically has a volume from about 0.010 to 0.10 ml, and with an average volume of 0.05 ml (20 drops equal 1 millimeter). The coolant sample is applied/dropped onto the first porous portion of the elongated body, which comprises the colored reagent.

In another embodiment, the test device can be immersed into the coolant at the radiator cap or the surge tank caps, thereby, eliminating the need to take a sample from the cooling system.

After the coolant is applied to the first porous portion of the elongated body and after a suitable period of time, the test device is folded to allow the first porous portion to contact the second porous portion (the blotter). The color of the second porous portion is determined. If there is insufficient corrosion inhibitor to precipitate the colored reagent, then the color reagent will be free to leave the first porous portion and be detected on the second porous portion (blotter pad). Conversely, if there is sufficient corrosion inhibitor to precipitate the colored reagent in the first porous portion, then there will be no free soluble colored reagent and the second porous portion (blotter pad) will not change color or be the color of the coolant.

The test device can be used in any environment including but not limited to mechanic shops, roadsides, stores, gas stations, and rest stops.

The colored reagent will react with the inhibitor ion present in the coolant to form an insoluble precipitate. The precipitate is trapped within the pore structure of the porous material. Only un-reacted and soluble components are free to egress from the reactive zone and be detected by their color on the blotter zone. If there is insufficient inhibitor in the coolant to substantially precipitate the colored reagent, then the colored reagent will be free to leave the reactive zone and be detected on the blotter zone. The amount of colored reagent in the reactive zone is chosen so that only coolants with sufficient carboxylate content will cause the colored reagent to precipitate. Thus, a blotter zone that exhibits a color of the colored reagent would have insufficient inhibitor and would suggest to the maintenance personnel that corrective action is needed for those coolants.

The amount of colored reagent complex in the reactive zone can be chosen depending on the level of inhibitor desired in the coolant. For example, in some situations, a very high level of inhibitor in a coolant would be required. In this situation, the reactive pad would require more colored reagent complex. In essence, the test device can be tailored to meet the needs of the end user.

### V. Kits

Embodiments disclosed herein also relate to kits. The kit may comprise one or more test devices and instructions for use. The kit may also include a wetting agent to improve wetting of the test substrate. Illustrative examples include non-ionic surfactants, an-ionic surfactants, and the like. In another embodiment, the kit may also comprise a stabilizing agent for preventing undesired degradation of the indicator and/or the metal salt. In one embodiment, the color indicator solution includes one or more organic or inorganic buffers for providing a suitable pH, which will not form an interfering complex with the tested coolant. Examples of buffers include borate buffers such as borax (sodium tetraborate). In another embodiment, the color indicator solution includes an additive for improved color development. for preparing the methods and compositions disclosed herein.

In another embodiment, the kit may also contain a pipette, an eye dropper, a stick, a syringe, or combinations thereof for aiding in obtaining a sample. In yet another embodiment, the kit may contain a reference color chart for determining the concentration of the inhibitor tested.

The methods, apparatuses, compositions and kits disclosed are now described with reference to the following Examples. These Examples are provided for the purpose of illustration only and the disclosure should in no way be construed as being limited to these Examples, but rather should be construed to encompass any and all variations that become evident as a result of the teaching provided herein.

### EXAMPLES

### Example 1

### Preparation of the Colored Reagent

An intensely orange color indicator stock solution was prepared by dissolving 0.425 grams of pyrocatechol violet (PVC) in deionized water to obtain 50.195 grams of solution. An aluminum ion containing solution was prepared by dissolving 3.43 grams of aluminum nitrite nonahydrate, Al(NO₃)₃.9H₂0, in deionized water to obtain 50.43 grams of solution.

A final impregnation solution was prepared by diluting 5.045 g of the PVC stock to 49.675 grams with deionized water and mixing this diluted indicator with the aluminum solution. Upon mixing, an intense blue soluble complex was formed between the aluminum ion and the PCV dye. No precipitate or solids were observed to form.

Porous Pads

Sheets of Ahlstrom blotter paper 237 will be cut to 3 inch by 2 inch sheets. Ahlstrom 237 is reported to have a retention of 3 microns and a loading capacity reported as “very high” in Ahlstrom's product selection manual. These sheets will be submersed in the aluminum indicator solution to totally saturate the pore structure of the Ahlstrom paper and then the paper will be air dried at room temperature and can then stored in a desicator for several days to remove all easily evaporated moisture. After drying, the Ahlstrom sheets will be cut into 0.25 inch pads.

Elongated Body

In one embodiment, 0.25″ strips of the impregnated paper will be affixed along one side of a square of LDPE sheet. Next, a 0.25″ strip of blotter paper will be affixed along the opposite edge of the square sheet. Then the LDPE square sheet will be cut orthogonal to the paper strips to obtain 0.25″ LPDE strips with a 0.25″ square of reaction zone at one end and a 0.25″ square of blotter a the other end. Thus the reaction zone and blotter zones will be applied to the LDPE as strips and not as pads.

In another embodiment, porous pads will then be affixed along one side of a low density poly ethylene (LDPE) sheet of 0.03 inch thickness. Along the opposite side of the LDPE sheet, 0.25 inch strip of unimpregnated Ahlstrom 237 paper will be affixed. Both sheets will be affixed using permanent double sided tape (Scotch brand from 3M). This composite sheet of LDPE with attached pads will then be cut into 0.25 inch wide strips such that a 0.25 inch square pad with the colored reagent will be located at one end of the strip and a 0.25 inch square of the unimpregnated paper will be located at the other end. The impregnated paper can be considered the reactive pad (the pad with the colored reagent) and the unimpregnated paper will be referred to as the pad without colored reagent (blotter pad).

### Example 2

Reference or test coolants were prepared as follows. Final Charge Global Extended Life 50/50 Prediluted Coolant/Antifreeze was diluted with deionized water to obtain dilutions of 80%, 60%, 40% and 20% of the 50/50 product. Final Charge Global Extended Life is a carboxylate inhibited coolant.

The blue reactive pad (reactive pad with colored reagent) of a test device from example 1 was immersed in the 50/50 product for sufficient time to allow complete saturation of the test pad with coolant (about 10 seconds). After immersion, the wetted pad was allowed to stand for sufficient time to allow coolant to react with the pad reagents (typically 10 seconds.) Finally, the reactive pad was brought into contact with the blotter pad (contains no colored reagent) and liquid from the reactive pad was blotted to the blotter pad. The color of the blotted pad was observed and recorded to be a shade similar to the starting 50/50 sample. In this case, the blotter pad appeared light red or pink.

This procedure was repeated with the remaining 4 reference solutions. The 80% solution was found to give a pink color to the blotted pad. The 60%, 40% and 20% solutions were observed to generate a blue color on the blotter pad. The color of the blotter pad indicated that the 50/50 coolant and the 80% reference have sufficient carboxylate inhibition to prevent the blue indicator complex in the reactive pad from bleeding to the blotter pad. There was sufficient carboxylate in the 50/50 coolant and the 80% reference to precipitate the vast majority, if not all, of the colored reagent. Tests of the 60%, 40% and 20% solutions revealed that there was insufficient carboxylate in these references to prevent the blue indicator complex from bleeding to the blotter. In these samples, there was insufficient carboxylate to precipitate all of the colored reagent, and thus, some of the colored reagent was transferred to the blotter pad.

TABLE 1
Test Strip Blotter Pad Color after
Reference Coolant Evaluation

| Reference Coolant | Blotter Pad Color |
|---|---|
| 50/50 Final Charge | Pink |
| 80% | Pink |
| 60% | Blue |
| 40% | Blue |
| 20% | Blue |

The blue aluminum PCV complex reacts with the carboxylate anion present in the coolant to form an insoluble precipitate. The precipitate will be trapped within the pore structure of the test pad paper, in this case Ahlstrom 237. As already noted Ahlstrom 237 has a particle size retention of 3 microns. Only unreacted and soluble component will be free to egress from the reactive pad and be detected by their color on the blotter pad. If there is insufficient carboxylate to precipitate all the colored complex, then the soluble blue indicator will be free to leave the reactive pad and be detected on the blotter pad. The amount of aluminum-PCV complex in the reactive pad is chosen so that only coolants with sufficient carboxylate content will cause all aluminum-PCV to precipitate. Thus, coolants that test blue have insufficient carboxylate and would suggest that corrective action is needed for those coolants. In these examples, the aluminum content was chosen such that the 60%, 40% and 20% coolant mixtures would indicate that corrective action was needed as judged by the blue color of the blotter pad.

### Example 3

Test devices were prepared as in example 1, with the exception that Ahlstrom 610 paper was used, which is reported to have a retention diameter even less than that of Ahlstorm 237. The retention diameter of 610 is 1.5 microns. The loading capacity of 610 is significantly less than that of 237 and is listed in the Ahlstrom brochure as “medium”. The test devices (reactive pad and blotter pad on LDPE strip) are evaluated as in example 2 and a color transition from pink to blue was again observed as the amount of carboxylate decreases below 80% of the 50/50 coolant. The load capacity of the reaction pad was not a limiting factor.

### Example 4

The reactive pad of a test device was prepared to contain aluminum nitrate by dissolving 3.5 grams of Al(NO₃)₃.9H₂0 in de-ionized water to obtain 100 grams of solution. Pads of Ahlstrom 237 filter paper were impregnated with this aluminum salt solution and dried as before. A 0.25 inch square of the dried aluminum salt paper is applied to an LPDE support strip. A second porous pad was prepared to contain the color indicator PCV by diluting 5.0 grams of yellow-orange PCV stock solution from example 1 to 100 grams using deionized water. This PCV solution was used to impregnate Ahlstrom 237 paper. The resulting yellow-orange impregnated paper was dried. A 0.25 inch square of dried PCV paper was applied to an LPDE support strip as before. It should be noted that the concentration of aluminum in the aluminum pad of this example was essentially the same as the aluminum concentration in example 1. Likewise, note that the PCV content of the PCV pad was essentially the same as that used in example 1. In this example, the aluminum and PCV components reside on different pads and thus have yet to be reacted to form the blue Al-PCV complex of example 1. The colored reagent complex is not on a single pad.

The aluminum pad was immersed in the 50/50 Final Charge reference as before. As before, reaction time was allotted to permit the coolant's carboxylate ion to fully react with the pad's aluminum to form the insoluble aluminum-carboxylate precipitate. As in example 2, there was sufficient carboxylate present in the 50/50 product to completely precipitate all aluminum in the current test pad. Following this reaction, the aluminum pad was contacted with the yellow PCV pad to transfer liquid from the aluminum pad to the PCV pad. The PCV pad is observed to change from yellow to an intense dark blue. The color change in this case was due to a reaction of PCV with the coolant's molybdate component, which also produces a blue metal PCV complex. In this example, the coolant test would be interpreted as a fail (i.e. a false fail) even though sufficient carboxylate was present to precipitate all aluminum in the aluminum pad. In example 2, the references containing more than 60% Final Charge gave a pink, passing color because the PCV has been pre-complexed with aluminum avoiding the molybdate interference seen in this example. (See Table 1.). This example clearly demonstrates the benefits and advantages of using a single pad comprising a complex of metal salt and color indicator. False results are minimized using the apparatuses and methods disclosed herein.

### Example 5

This example demonstrates that the test devices and methods disclosed herein are not limited to indicator pads containing aluminum salts. Soluble colored compound that will react with carboxylate to form an insoluble precipitate can be used as the reactive indicator in the reactive pad of the present invention. In this example, a solution was prepared by dissolving 3.455 grams of ferric chloride hexahydrate (FeCl₃.6H20) in deionized water to obtain 49.985 grams of solution. A second stock solution of pyrocatechol violet (PCV) was prepared by dissolving 0.430 grams of PCV in deionized water to obtain 50.125 grams of solution. A third solution was prepared by diluting 14.0 grams of the PCV stock solution to 50.020 grams with deionized water. This final PCV solution was then mixed with the first ferric chloride solution. The mixture was observed to form a very dark (green-black) indicator solution. Sheets of Ahlstrom 237 blotter paper were impregnated with this indicator solution. The impregnated sheets were air-dried over night and then desiccated in a closed container over drying agent for 5 days. The resulting dried indicator paper was colored a dark green. The indicator paper was cut into ⅜″ strips, each strip mounted to one end of a sheet of low density polyethylene (LDPE), approximately 1/16″ thick. The LDPE sheet is approximately 3.5″ square. The resulting composite was then cut into several ⅜″ strips, to obtain a final test strip that is ⅜″ wide by 3.5″ long with the indicator test paper at one end of the LDPE strip. The indicator pad is approximately ⅜″ square.

Five test strips are evaluated using five reference carboxylate coolants (a 50/50 pre-diluted Final Charge Global Extended Life Coolant as well as further dilutions at 80%, 60%, 40% and 20% of the starting 50/50 Prediluted Final Charge.) Each test strip was immersed in each reference coolant for a period of 10 seconds, then removed from the coolant, shaken briskly to remove excess coolant and held for an additional 10 seconds to allow complete reaction. The test pad was then pressed against a blank sheet of Ahlstrom 237 paper, which served as a blotter to remove reacted coolant from the indicator pad. The blotting action allows observation of the coolants color on the blotter sheet following reaction in the indicator pad. If there is sufficient carboxylate in the Final Charge reference to completely precipitate all of the ferric chloride—PCV complex in the indicator pad, the blotter will assume the color of the coolant (in this case, pink). If however, there is insufficient carboxylate to precipitate all the indicator in the indicator pad, free, green-black indicator will move from the indicator pad to the blotter during the blotting step and be detected as a green-black area on the blotter pad.

In this example, the reactive pad of a test device immersed in the Prediluted Final Charge will give a blot that is essentially the color of Final Charge—pink. Likewise a test strip immersed in the Prediluted Final Charge that has been further diluted to 80% also gives a pink indication on the blotter pad again indicating that there was sufficient carboxylate in both of these references to cause complete precipitation of the ferric chloride—PCV complex. Immersion of test strips into the 60%, 40% and 20% dilutions generated a dark green area on the blotter indicating insufficient carboxylate for complete indicator precipitation. The amount of ferric chloride and PCV can be adjusted so as to change the point at which this color transition is observed. If more complex is impregnated into the indicator pad, then more carboxylate will be needed to effect complete precipitation of the green indicator. Conversely, if less is used, less carboxylate will be needed to effect precipitation. In this way, the “Pass/Fail” point of the indicator pad can be adjusted to reflect the carboxylate coolant level needed for adequate corrosion protection. A passing coolant gives a pink blot while a failing coolant gives a green blot.

### Example 6

In this example, it is shown that the test devices and methods disclosed herein are not limited to reactive pads containing trivalent cations such as Fe⁺³ or Al⁺³ salts. Any soluble colored compound that will react with carboxylate to form an insoluble precipitate can be used as the reactive indicator in the reactive pad. The following example demonstrates that tetravalent cation, Sn⁺⁴ can be used to prepare the reactive pad of the test device disclosed herein.

In this embodiment, a solution was prepared by dissolving 2.430 grams of stannic chloride pentahydrate (SnCl₄.5H20) in deionized water to obtain 50.010 grams of solution. A second stock solution of pyrocatechol violet (PCV) was prepared by dissolving 0.430 grams of PCV in deionized water to obtain 49.995 grams of solution. A third solution was prepared by diluting 5.01 grams of the PCV stock solution to 50.060 grams with deionized water. This final PCV solution was then mixed with the first stannic chloride solution. The mixture is observed to form a very dark royal blue indicator solution. Sheets of Ahlstrom 237 blotter paper were impregnated with this indicator solution. The impregnated sheets were air-dried over night and then desiccated in a closed container over drying agent for 3 days. The resulting dried indicator paper was colored a royal or cobalt blue. The indicator paper was cut into ⅜″ strips, each strip mounted to one end of a sheet of low density polyethylene (LDPE), approximately 1/16″ thick. The LDPE sheet was approximately 3.5″ square. The resulting composite was then cut into several ⅜″ strips, to obtain a final test strip that is ⅜″ wide by 3.5″ long with the indicator test paper at one end of the LDPE strip. The indicator pad was approximately ⅜″ square.

Five test strips were evaluated using five reference carboxylate coolants (a 50/50 pre-diluted Final Charge Global Extended Life Coolant as well as further dilutions at 80%, 60%, 40% and 20% of the starting 50/50 Prediluted Final Charge.) The reactive pad of each test device was immersed in each reference coolant for a period of 10 seconds, then removed from the coolant, shaken briskly to remove excess coolant and held for an additional 10 seconds to allow complete reaction. The test pad was then pressed against a fresh sheet of Ahlstrom 237 paper, which serves as a blotter to remove reacted coolant from the indicator pad. The blotting action allows observation of the coolants color on the blotter sheet following reaction in the indicator pad. If there is sufficient carboxylate in the Final Charge reference to completely precipitate all of the stannic chloride—PCV complex in the indicator pad, the blotter will assume the color of the coolant (in this case, pink). If however, there is insufficient carboxylate to precipitate all the indicator in the indicator pad, free, blue indicator will move from the indicator pad to the blotter during the blotting step and be detected as a blue area on the blotter pad.

In this example, the reactive pad of a test device immersed in the Prediluted Final Charge will give a blot that is essentially the color of Final Charge—pink. Likewise a test strip immersed in the Prediluted Final Charge that has been further diluted to 80% also gives a pink indication on the blotter pad again indicating that there was sufficient carboxylate in both of these references to cause complete precipitation of the stannic chloride—PCV complex. Immersion of the reactive pad of test strips into the 40% and 20% dilutions generated a blue area on the blotter indicating insufficient carboxylate for complete indicator precipitation. Immersion of a strip in the 60% reference gives an intermediate result with both blue and pink areas observable. The amount of stannic chloride and PCV can be adjusted so as to change the point at which this color transition is observed. If more complex is impregnated into the indicator pad, then more carboxylate will be needed to effect complete precipitation of the blue indicator. Conversely, if less is used, less carboxylate will be needed to effect precipitation. In this way, the “Pass/Fail” point of the indicator pad can be adjusted to reflect the carboxylate coolant level needed for adequate corrosion protection. A passing coolant gives a pink blot while a failing coolant gives a blue blot in this embodiment of the invention.

Although specific embodiments have been illustrated and described herein, it will be appreciated by those of ordinary skill in the art that any arrangement that is calculated to achieve the same purpose may be substituted for the specific embodiments shown. This application is intended to cover any adaptations or variations that operate according to the principles of the invention as described. Therefore, it is intended that this disclosure be limited only by the claims and the equivalents thereof. The disclosures of patents, references and publications cited in the application are incorporated by reference herein in their entirety.

What is claimed is:

1. A test device comprising an elongated body with a first porous portion and a second porous portion located on opposite ends of the elongated body, wherein the first porous portion comprises a colored reagent comprising a soluble metal salt and a color indicator and the second porous portion is free of colored reagent, and further wherein the elongated body permits contact between the first porous portion and the second porous portion.

2. A test device comprising a first substrate comprising a porous reaction zone comprising a colored reagent and a second substrate comprising a porous zone that is free of colored reagent.

3. The test device of claim 1, wherein the soluble metal salt comprises an aluminum salt.

4. The test device of claim 3, wherein the aluminum salt is selected from the group consisting of aluminum chloride, aluminum sulfate, aluminum nitrate and their hydrates.

5. The test device of claim 1, wherein the soluble metal salt comprises an iron salt.

6. The test device of claim 5, wherein the iron salt is selected from the group consisting of iron chloride, iron sulfate, iron nitrate and their hydrates.

7. The test device of claim 1, wherein the soluble metal salt comprises a tin salt.

8. The test device of claim 7, wherein the tin salt is selected from the group consisting of tin chloride, tin sulfate, tin nitrate and their hydrates.

9. The test device of claim 1, wherein the elongated body is a strip of non-porous material.

10. The test device of claim 1, wherein the first and second porous portions are pads of filter paper.

11. The test device of claim 1, wherein the color indicator is PVC.

12. A method for determining the presence or absence of a corrosion-inhibitory level of an inhibitor in a coolant fluid comprising:
(a) providing a test substrate comprising a first porous portion comprising a colored reagent of metal salt and a color indicator and a second porous portion free of the colored reagent;
(b) bringing a sample of a coolant fluid into contact with the first porous portion, wherein the inhibitor in the coolant precipitates the colored reagent in the first porous pad;
(c) bringing the first porous portion into contact with the second porous portion; and
(d) observing any color change in the second porous portion due to un-precipitated color reagent in the first porous pad.
